(19) United States
(12) Patent Application Publication
(10) Pub. No.: US 2024/0038982 A1
(43) Pub. Date: Feb. 1, 2024

(54) A POSITIVE ELECTRODE ACTIVE MATERIAL FOR RECHARGEABLE LITHIUM-ION BATTERIES

(71) Applicant: UMICORE, Brussels (BE)

(72) Inventors: JiHye KIM, Chungcheongnam-do (KR); Jens Martin PAULSEN, Chungcheongnam-do (KR)

(21) Appl. No.: 18/265,527

(22) PCT Filed: Dec. 14, 2021
(86) PCT No.: PCT/EP21/85742

§ 371 Date: Jun. 6, 2023

(30) Foreign Application Priority Data
Dec. 15, 2020 (EP) 20214299.8

(51) Int. Cl. H01M 4/525; H01M 4/505; C01G 53/00

(52) U.S. Cl. CPC H01M 4/525; H01M 4/505; C01G 53/006; H01M 2004/021

(57) ABSTRACT

A positive electrode active material for batteries which comprises Li, M′, and oxygen, wherein M′ comprises: Ni in a content a between 70.0 mol % and 95.0 mol %; Co in a content x between 0.0 mol % and 25.0 mol %; Mn in a content y between 0.0 mol % and 25.0 mol %, a dopant D in a content z between 0.0 mol % and 2.0 mol %, Al and B in a total content c between 0.1 mol % and 5.0 mol %, wherein the active material has an Al content Al_{A} and a B content B_{A}, wherein a, x, y, z, c, Al_{A} and B_{A} are measured by ICP, wherein Al_{A}, and B_{A} are expressed as molar fractions compared to the sum of a and x and y, wherein the positive electrode active material, when measured by XPS analysis, shows an average Al fraction Al_{B} and an average B fraction B_{B}, wherein the ratio Al_{B}/Al_{A}>1.0, wherein the ratio B_{B}/B_{A}>1.0, and wherein the positive electrode active material is a single-crystalline powder.

### TECHNICAL FIELD

The present invention relates to a positive electrode active material for lithium-ion rechargeable batteries. More specifically, the invention relates to particulate positive electrode active materials comprising Al and B elements; a battery comprising said particulate positive electrode active materials comprising Al and B elements; and, use of said positive electrode active material in a battery in either one of portable computer, a tablet, a mobile phone, an electrically powered vehicle, and an energy storage system.

### BACKGROUND

This invention relates to a single-crystalline positive electrode active material powder for lithium-ion rechargeable batteries (LIBs), comprising the elements Al and B.

Positive electrode active materials comprising Al and B elements are already known, for example from US 2016/336595. The document US 2016/336595 discloses a positive electrode active material powder made from a mixture of a lithium nickel manganese cobalt oxide (NMC) powder, Al(OH)₃ powder, and B₂O₃ powder heated at 400° C. The Ni content in the NMC is around 60 mol %. However, the positive electrode active material according to US 2016/336595 has low initial discharge capacity (DQ1) and high irreversible capacity (IRRQ).

It is therefore an object of the present invention to provide a positive electrode active material having a higher DQ1 and a lower IRRQ than known materials. In particular, it is an object of the present invention to provide a positive electrode active material which preferably has DQ1 higher than 215.0 mAh/g and IRRQ lower than 9.5% when the molar ratio of Ni to M′ is higher than 80 mol % as obtained by the analytical method of the present invention and preferably at least 185 mAh/g and IRRQ lower than 12% when the molar ratio of Ni to M′ is at least 70 mol % as obtained by the analytical method of the present invention.

### SUMMARY OF THE INVENTION

This objective is achieved by providing a positive electrode active material for lithium-ion rechargeable batteries, wherein the positive electrode active material is a powder, wherein the positive electrode active material comprises Li, M′, and oxygen, wherein M′ comprises:
Ni in a content a between 70.0 mol % and 95.0 mol %, relative to M′,
Co in a content x between 0.0 mol % and 25.0 mol %, relative to M′,
Mn in a content y between 0.0 mol % and 25.0 mol %, relative to M′,
D in a content z between 0.0 mol % and 2.0 mol %, relative to M′, wherein D comprises at least one element of the group consisting of: Ba, Ca, Cr, Fe, Mg, Mo, Nb, S, Si, Sr, Ti, Y, V, Zn, W, and Zr, and,
Al and B, wherein the total content c of Al and B is between 0.1 mol % and 5.0 mol %, relative to M′,
wherein a, x, y, z, and c are measured by ICP,
wherein a+x+y+c+z is 100.0 mol %,
wherein the positive electrode active material has an Al content Al_{A} and a B content B_{A}, wherein Al_{A} and B_{A} are determined by ICP analysis, wherein Al_{A}, and B_{A} are expressed as molar fractions compared to the sum of a and x and y,
wherein the powder, when measured by XPS analysis, shows an average Al fraction Al_{B} and an average B fraction B_{B}, wherein Al_{B} and B_{B} are expressed as molar fractions compared to the sum of the fractions of Co, Mn and Ni as measured by XPS analysis,
wherein the ratio Al_{B}/Al_{A}>1.0,
wherein the ratio B_{B}/B_{A}>1.0, and

wherein the powder is a single-crystalline powder.

It is indeed observed that a higher DQ1 and a lower IRRQ is achieved using a positive electrode active material according to the present invention, as illustrated by examples and supported by the results provided in Table 3.

Further, in a first aspect the present invention provides an electrochemical cell comprising a positive electrode active material according to the first aspect of the invention, in a second aspect, the present invention provides a battery cell comprising a positive electrode active material according to the first aspect of the invention and in a third aspect the present invention a use of a positive electrode active material according to the first aspect of the invention in a battery.

### BRIEF DESCRIPTION OF THE FIGURES

By means of further guidance, a figure is included to better appreciate the teaching of the present invention. Said figure is intended to assist the description of the invention and is nowhere intended as a limitation of the presently disclosed invention.

FIG. 1 shows a Scanning Electron Microscope (SEM) image of a positive electrode active material powder according to EX4 with single-crystalline morphology.

FIG. 2a shows comparison of DQ1 for examples and comparative examples as the function of nickel content in the positive electrode active material; FIG. 2b shows comparison of IRRQ for examples and comparative examples as the function of nickel content in the positive electrode active material.

FIG. 3a shows XPS spectra of EX4.2 measured in the range of 66 to 80 eV comprising Al2p and Ni3p peak; FIG. 3b shows XPS spectra of EX4.2 measured in the range of 187 to 197 eV comprising B1s peak.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention. As used herein, the following terms have the following meanings:

The recitation of numerical ranges by endpoints includes all numbers and fractions subsumed within that range, as well as the recited endpoints. All percentages are to be understood as percentage by weight, abbreviated as “wt. %”, unless otherwise defined or unless a different meaning is obvious to the person skilled in the art from its use and in the context wherein it is used.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

The term ‘ppm’ is as used in this document means parts per million on a mass basis.

The term “median particle size D50”, as defined herein, can be interchangeably used with the terms “D50” or “d50” or “median particle size” or “a median particle size (d50 or D50)”. D50 is defined herein as the particle size at 50% of the cumulative volume % distributions. D50 is typically determined by laser diffraction particle size analysis.

The term “at %”, as defined herein, is equivalent to the term “atomic percent” and signifies atomic percentage. The term “at %” of a given element expression of a concentration means how many percent of all atoms in the concerned compound are atoms of said element. The term “at %” is equivalent to the terms “mol %” or “molar percent”.

A positive electrode active material is defined as a material which is electrochemically active in a positive electrode. By active material, it must be understood a material capable to capture and release Li ions when subjected to a voltage change over a predetermined period of time.

### Positive Electrode Active Material

In a first aspect, the present invention provides a positive electrode active material for lithium-ion rechargeable batteries, wherein the positive electrode active material is a powder, wherein the positive electrode active material comprises Li, M′, and oxygen, wherein M′ comprises:
Ni in a content a between 70.0 mol % and 95.0 mol %, relative to M′,
Co in a content x between 0.0 mol % and 25.0 mol %, relative to M′,
Mn in a content y between 0.0 mol % and 25.0 mol %, relative to M′,
D in a content z between 0.0 mol % and 2.0 mol %, relative to M′, wherein D comprises at least one element of the group consisting of: Ba, Ca, Cr, Fe, Mg, Mo, Nb, S, Si, Sr, Ti, Y, V, Zn, W, and Zr,
Al and B, wherein the total content c of Al and B is between 0.1 mol % and 5.0 mol %, relative to M′, wherein a, x, y, z, and c are measured by ICP,
wherein a+x+y+c+z is 100.0 mol %,
wherein the positive electrode active material has an Al content Al_{A} and a B content B_{A}, wherein Al_{A} and B_{A} are determined by ICP analysis, wherein Al_{A}, and B_{A} are expressed as molar fractions compared to the sum of a and x and y,
wherein the powder, when measured by XPS analysis, shows an average Al fraction Al_{B} and an average B fraction B_{B}, wherein Al_{B} and B_{B} are expressed as molar fractions compared to the sum of the fractions of Co, Mn and Ni as measured by XPS analysis,
wherein the ratio Al_{B}/Al_{A}>1, wherein the ratio B_{B}/B_{A}>1, and
wherein the powder is a single crystalline powder.

A single-crystalline powder is considered to be a powder in which 80% or more of the particles in a field of view of at least 45 μm×at least 60 μm (i.e. of at least 2700 μm²), preferably of: at least 100 μm×100 μm (i.e. of at least 10,000 μm²) in a SEM image have a single-crystalline morphology.

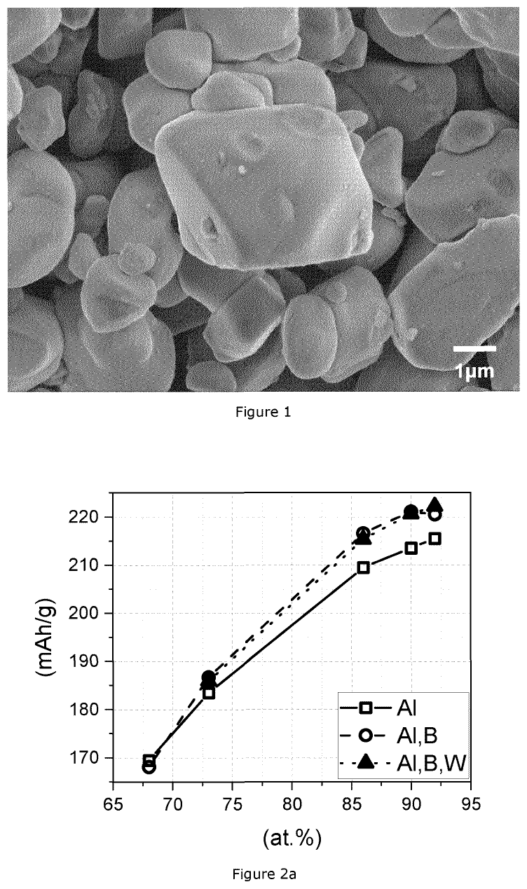

A particle is considered to have single-crystalline morphology if it consists of only one grain, or a very low number of a most five, constituent grains, as observed by SEM or TEM. For instance, particles with single-crystalline morphology are shown in FIG. 1 which is the SEM image of EX4.

For the determination of single-crystalline morphology of particles, grains which have a largest linear dimension as observed by SEM which is smaller than 20% of the median particle size D50 of the powder as determined by laser diffraction are ignored. This avoids that particles which are in essence single-crystalline, but which may have deposited on them several very small other grains, are inadvertently considered as not having a single-crystalline morphology.

A positive electrode active material for lithium-ion rechargeable batteries according to the present invention indeed has improved electrochemical properties when used in an electrochemical cell allowing a higher DQ1 and lower IRRQ to be achieved. This is illustrated by examples and the results provided in the Table 3.

The XPS analysis provides atomic content of elements in an uppermost layer of a particle with a penetration depth of about 10.0 nm from an outer boundary of the particle. The outer boundary of the particle is also referred to as “surface”.

The composition of the positive electrode active material particle can be expressed as the indices a, x, y, z, a, and d in a general formula Li_{1+b}(NiₐMn_{y}CoₓA_{c}D_{z})_{1-b}O₂, according to the stoichiometry of the elements determined by known analysis methods, such as ICP-OES (Inductively coupled plasma-optical emission spectrometry, also referred hereafter as ICP) and IC (ion chromatography). ICP analysis provides the weight fraction of elements in a positive electrode active material particle.

Preferably, the positive electrode active material has a nickel content a, relative to M′, of more than 75.0 mol %, and more preferably at least 80.0 mol %, as measured by ICP.

Preferably, the positive electrode active material has a cobalt content x, relative to M′, of at least 1 mol %, more preferably at least 2 mol % or even more preferably at least 3 mol %, as measured by ICP. The present invention provides a positive electrode active material which has a cobalt content x of 3.0, 5.0, 7.0, 9.0, or 10.0 mol %, relative to M′, as measured by ICP, or any value there in between.

Preferably, the positive electrode active material has a manganese content y, relative to M′, of at least 1 mol %, more preferably at least 2 mol % or even more preferably at least 3 mol %, as determined by ICP. The present invention provides a positive electrode active material which has a manganese content y of 3.0, 5.0, 7.0, 9.0, or 10.0 mol %, relative to M′, as measured by ICP, or any value there in between.

Preferably, the present invention provides a positive electrode active material wherein a molar ratio of lithium to the total molar amount of nickel, manganese, and/or cobalt is 0.95≤Li:Me≤1.10 wherein Me is a total molar fraction of Ni, Mn, and/or Co.

Preferably, the present invention provides a positive electrode active material according to the first aspect of the invention, wherein the total content of Al and B relative to M′ as measured by ICP, is preferably at least 0.1 mol %, and more preferably at least 0.4 mol %, relative to M′. The total content of Al and B relative to the M′ as measured by ICP, is preferably at most 2.0 mol %.

Preferably, the positive electrode active material of the present comprises Al and B and W, each in a content of at least 0.02 mol % relative to M′, as measured by ICP.

Preferably, Al_{A} is between 0.025 mol % and 2.0 mol %, is expressed as a molar fraction compared to the sum of a and x and y, as measured by ICP.

Preferably, B_{A} is between 0.025 mol % and 2.0 mol %, are expressed as molar fractions compared to the sum of a and x and y, as measured by ICP.

Preferably, the positive electrode active material of the present invention has a W content W_{A}, wherein W_{A} is determined by ICP analysis and expressed as molar fraction compared to the sum of a and x and y, wherein the positive electrode active material, when measured by XPS analysis, shows an average W fraction W_{B}, wherein W_{B} is expressed as molar fraction compared to the sum of the fractions of Co, Mn and Ni as measured by XPS analysis, wherein the ratio W_{B}/W_{A}>1.0.

Preferably, W_{A} is between 0.025 mol % and 2.0 mol %, are expressed as molar fractions compared to the sum of a and x and y, as measured by ICP.

Preferably, B_{A} is at least 0.0009, in other words at least 0.09 mol %, and more preferably B_{A} is at least 0.0018, in other words at least 0.18 mol %, are expressed as molar fractions compared to the sum of a and x and y, as measured by ICP.

Preferably, Al_{A} is at most 0.008, in other words at most 0.8 mol %, are expressed as molar fractions compared to the sum of a and x and y, as measured by ICP.

In preferred embodiments:
the ratio Al_{B}/Al_{A}<800 and/or;
the ratio B_{B}/B_{A}<500 and/or.

In more preferred embodiments:
the ratio Al_{B}/Al_{A}>10 and/or;
the ratio B_{B}/B_{A}>10.

In even more preferred embodiments:
the ratio Al_{B}/Al_{A}>150 and/or;
the ratio B_{B}/B_{A}>100.

Preferably, the ratio W_{B}/W_{A}>10, and more preferably the ratio W_{B}/W_{A}>50, and most preferably the ratio W_{B}/W_{A}>115.

In a preferred embodiment the ratio W_{B}/W_{A}<500.

Preferably, the present invention provides a positive electrode active material according to the first aspect of the invention, wherein the positive electrode active material has a median particle size (d50 or D50) of 2.0 μm to 9.0 μm, as determined by laser diffraction. The median particle size (d50 or D50) can be measured with a Malvern Mastersizer 3000. Preferably, said median particle size is between 2.0 μm and 8.0 μm, more preferably between 3.0 μm and 7.0 μm, and most preferably about 4.0 μm.

Preferably, the present invention provides a positive electrode active material according to the first aspect of the invention, wherein said positive electrode active material has a DQ1 of at least 215 mAh/g and IRRQ of at most 9.5%, when the molar ratio of Ni to M′ is higher than 80 mol %, and more preferably said positive electrode active material has a DQ1 of at least 185 mAh/g and IRRQ of at most 12%, when the molar ratio of Ni to M′ is between 70 mol % and 75 mol %. Said DQ1 and IRRQ are determined by a coin cell testing procedure using a 1C current definition of 220 mAh/g when the molar ratio of Ni to M′ is higher than 80 mol. % and 1C current definition of 160 mA/g in the 4.4-3.0 V/Li metal window range. The testing procedure is further described in § 1.3 and included hereby by reference.

Preferably, the positive electrode active material according to the first aspect of the invention comprises LiAlO₂, Al₂O₃, and Li—B—O compounds as identified by XPS.

### Electrochemical Cell

In a second aspect, the present invention provides a battery cell comprising a positive electrode active material according to the first aspect of the invention.

In a third aspect, the present invention provides a use of a positive electrode active material according to the first aspect of the invention in a battery of either one of a portable computer, a tablet, a mobile phone, an electrically powered vehicle, and an energy storage system.

### EXAMPLES

The following examples are intended to further clarify the present invention and are nowhere intended to limit the scope of the present invention.

### 1. Description of Analysis Method

### 1.1. Inductively Coupled Plasma

The composition of a positive electrode active material powder is measured by the inductively coupled plasma (ICP) method using an Agilent 720 ICP-OES (Agilent Technologies, https://www.agilent.com/cs/library/brochures/5990-6497EN%20720-725_ICP-OES_LR.pdf). 1 gram of powder sample is dissolved into 50 mL of high purity hydrochloric acid (at least 37 wt. % of HCl with respect to the total weight of solution) in an Erlenmeyer flask. The flask is covered by a watch glass and heated on a hot plate at 380° C. until the powder is completely dissolved. After being cooled to room temperature, the solution from the Erlenmeyer flask is poured into a first 250 mL volumetric flask. Afterwards, the first volumetric flask is filled with deionized water up to the 250 mL mark, followed by a complete homogenization process (1^{st} dilution). An appropriate amount of the solution from the first volumetric flask is taken out by a pipette and transferred into a second 250 mL volumetric flask for the 2^{nd} dilution, where the second volumetric flask is filled with an internal standard element and 10% hydrochloric acid up to the 250 mL mark and then homogenized. Finally, this solution is used for ICP measurement.

### 1.2. Particle Size Distribution

The particle size distribution (PSD) of the positive electrode active material powder is measured by laser diffraction particle size analysis using a Malvern Mastersizer 3000 with a Hydro MV wet dispersion accessory (https://www.malvernpanalytical.com/en/products/product-range/mastersizer-range/mastersizer-3000#overview) after having dispersed each of the powder samples in an aqueous medium. In order to improve the dispersion of the powder, sufficient ultrasonic irradiation and stirring is applied, and an appropriate surfactant is introduced. D50 is defined as the particle size at 50% of the cumulative volume % distributions obtained from the Malvern Mastersizer 3000 with Hydro MV measurements.

### 1.3. Coin Cell Test

### 1.3.1. Coin Cell Preparation

Coin Cell Preparation for CEX1, EX1.1, EX1.2, CEX2, EX2.1, EX2.2, CEX3, EX3.1, EX3.3

For the preparation of a positive electrode, a slurry that contains a positive electrode active material powder, conductor (Super P, Timcal), binder (KF #9305, Kureha)—with a formulation of 96.5:1.5:2.0 by weight—in a solvent (NMP, Mitsubishi) is prepared by a high-speed homogenizer. The homogenized slurry is spread on one side of an aluminum foil using a doctor blade coater with a 170 μm gap. The slurry coated foil is dried in an oven at 120° C. and then pressed using a calendaring tool with 10 μm gap.

Then it is dried again in a vacuum oven to completely remove the remaining solvent in the electrode film. A coin cell is assembled in an argon-filled glovebox. A separator (Celgard 2320) is located between a positive electrode and a piece of lithium foil used as a negative electrode. 1 M LiPF₆ in EC/DMC (1:2) is used as electrolyte and is dropped between separator and electrodes. Then, the coin cell is completely sealed to prevent leakage of the electrolyte.

Coin Cell Preparation for CEX4, EX4.1, EX4.2, CEX5.1, CEX5.2

For the preparation of a positive electrode, a slurry that contains a positive electrode active material powder, conductor (Super P, Timcal), binder (KF #9305, Kureha)—with a formulation of 90:5:5 by weight—in a solvent (NMP, Mitsubishi) is prepared by a high-speed homogenizer. The homogenized slurry is spread on one side of an aluminum foil using a doctor blade coater with a 230 μm gap. The slurry coated foil is dried in an oven at 120° C. and then pressed using a calendaring tool with 40 μm gap.

Then it is dried again in a vacuum oven to completely remove the remaining solvent in the electrode film. A coin cell is assembled in an argon-filled glovebox. A separator (Celgard 2320) is located between a positive electrode and a piece of lithium foil used as a negative electrode. 1 M LiPF₆ in EC/DMC (1:2) is used as electrolyte and is dropped between separator and electrodes. Then, the coin cell is completely sealed to prevent leakage of the electrolyte.

### 1.3.2. Testing Method

The testing method is a conventional “constant cut-off voltage” test. The conventional coin cell test in the present invention follows the schedule shown in Table 1. Each cell is cycled at 25° C. using a Toscat-3100 computer-controlled galvanostatic cycling station (from Toyo, http://www.toyosystem.com/image/menu3/toscat/TOSCAT-3100.pdf).

1C current definition for CEX1, EX1.1, EX1.2, CEX2, EX2.1, EX2.2, CEX3, EX3.1, and EX3.3 is 220 mAh/g and for CEX4, EX4.1, EX4.2, CEX5.1, CEX5.2 is 160 mAh/g. The initial charge capacity (CQ1) and discharge capacity (DQ1) are measured in constant current mode (CC) at C rate of 0.1C in the 4.3 V to 3.0 V/Li metal window range.

The irreversible capacity IRRQ is expressed in % as follows:

IRRQ (%)=100%*(CQ1−DQ1)/CQ1

TABLE 1
Cycling schedule for Coin cell testing method

| C | End | Rest | V/Li | C | End | Rest | V/Li |
|---|---|---|---|---|---|---|---|
| Rate | current | (min) | metal (V) | Rate | current | (min) | metal (V) |
| 0.1 | − | 30 | 4.3 | 0.1 | − | 30 | 3.0 |

### 1.4. X-Ray Photoelectron Spectroscopy (XPS)

In the present invention, X-ray photoelectron spectroscopy (XPS) is used to analyze the surface of positive electrode active material powder particles. In XPS measurement, the signal is acquired from the first few nanometers (e.g. 1 nm to 10 nm) of the uppermost part of a sample, i.e. surface layer. Therefore, all elements measured by XPS are contained in the surface layer.

For the surface analysis of positive electrode active material powder particles, XPS measurement is carried out using a Thermo K-α+ spectrometer (Thermo Scientific, https://www.thermofisher.com/order/catalog/product/IQLAADGAAFFACVMAHV). Monochromatic Al Kα radiation (hu=1486.6 eV) is used with a spot size of 400 μm and measurement angle of 45°. A wide survey scan to identify elements present at the surface is conducted at 200 eV pass energy. Cis peak having a maximum intensity (or centered) at a binding energy of 284.8 eV is used as a calibrate peak position after data collection. Accurate narrow-scans are performed afterwards at 50 eV for at least 10 scans for each identified element to determine the precise surface composition.

Curve fitting is done with CasaXPS Version 2.3.19PR1.0 (Casa Software, http://www.casaxps.com/) using a Shirley-type background treatment and Scofield sensitivity factors. The fitting parameters are according to Table 2a. Line shape GL(30) is the Gaussian/Lorentzian product formula with 70% Gaussian line and 30% Lorentzian line. LA(α, β, m) is an asymmetric line-shape where α and β define tail spreading of the peak and m define the width.

TABLE 2a
XPS fitting parameter for Ni2p3, Mn2p3, Co2p3, Al2p, and F1s.

| | Sensitivity | Fitting range | | Line |
|---|---|---|---|---|
| Element | factor | (eV) | Defined peak(s) | shape |
| Ni | 14.61 | 851.1 ± 0.1- | Ni2p3, Ni2p3 satellite | LA(1.33, |
| | | 869.4 ± 0.1 | | 2.44, 69) |
| Mn | 9.17 | 639.9 ± 0.1- | Mn2p3, Mn2p3 satellite | GL(30) |
| | | 649.5 ± 0.1 | | |
| Co | 12.62 | 775.4 ± 0.1- | Co2p3-1, Co2p3-2, | GL(30) |
| | | 792.7 ± 0.3 | Co2p3 satellite | |
| Al | 0.54 | 78.5 ± 0.1- | Al2p peak 1, Al2p peak | GL(30) |
| | | 64.1 ± 0.1 | 2, Al2p peak 3, Ni3p1, | |
| | | | Ni3p3, Ni3p1 satellite, | |
| | | | Ni3p3 satellite | |
| B | 0.49 | 186.0 ± 0.1- | B1s peak 1, B1s peak 2 | GL(30) |
| | | 196.3 ± 0.1 | | |
| W | 9.8 | 32.0 ± 0.1- | W4f7, W4f5, and W5p3 | GL(30) |
| | | 43.0 ± 0.1 | | |

For Al, B, Co, and W peaks, constraints are set for each defined peak according to Table 2b. Ni3p and W5p3 are not quantified.

TABLE 2b
XPS fitting constraints for Al2p peak fitting.

| | | Fitting range | FWHM | |
|---|---|---|---|---|
| Element | Defined peak | (eV) | (eV) | Area |
| Al | Ni3p3 | 65.7-68.0 | 0.5-2.9 | No constraint set |
| | Ni3p1 | 68.0-70.5 | 0.5-2.9 | 50% of Ni3p3 area |
| | Ni3p3 satellite | 70.5-72.5 | 0.5-2.9 | 40% of Ni3p3 area |
| | Ni3p1 satellite | 72.5-75.0 | 0.5-2.9 | 20% of Ni3p3 area |
| | Al2p peak 1 | 72.6-73.2 | 0.5-1.5 | No constraint set |
| | Al2p peak 2 | 73.5-73.9 | 0.5-1.5 | No constraint set |
| | Al2p peak 3 | 73.9-74.7 | 0.5-1.5 | No constraint set |
| B | B1s peak 1 | 192.1-192.3 | 0.1-1.5 | No constraint set |
| | B1s peak 2 | 192.8-193.6 | 0.1-1.5 | No constraint set |
| Co | Co2p3-1 | 776.0-780.9 | 0.5-4.0 | No constraint set |
| | Co2p3-2 | 781.0-785.0 | 0.5-4.0 | No constraint set |
| | Co2p3 satellite | 785.1-792.0 | 0.5-6.0 | No constraint set |
| W | W4f7 | 33.0-36.0 | 0.2-4.0 | No constraint set |
| | W4f5 | 36.1-39.0 | Same as | 75% of W4f7 area |
| | | | W4f7 | |
| | W5p3 | 39.1-43.0 | 0.5-2.5 | No constraint set |

Table 2c shows the reference of the maximum peak intensity position range for the Al and B related compounds.

TABLE 2c
XPS peak reference

| | Binding | | |
|---|---|---|---|
| | Energy range | Compound | |
| Peak | (eV) | attributed | Literature reference |
| Al peak1* | 72.6-73.1 | LiAlₙMe₁₋ₙO₂ | Chem. Mater. Vol. 19, No. 23, 5748- |
| Al peak2 | 73.5-73.9 | LiAlO₂ | 5757, 2007; J. Electrochem. Soc., 154 |
| | | | (12) A1088-1099, 2007; and Chem. |
| | | | Mater. Vol. 21, No.23, 5607-5616, 2009. |
| Al peak3 | 73.9-74.7 | Al₂O₃ | Wagner, C. D., Handbook of XPS, Perkin- |
| | | | Elmer, 1979; Moulder, J. F., Handbook of |
| | | | XPS, Perkin-Elmer, 1992 |
| B peak 1 | 192.1-192.3 | Li—B—O | Direct measurement on Li₂B₄O₇ and |
| | | | Li₄B₂O₅ powder |
| B peak 2 | 192.8-193.6 | H₃BO₃ | Wagner, C. D., Handbook of XPS, Perkin- |
| | | | Elmer, 1979; Appl. Surf. Sci. Vol. 40, |
| | | | 249-263, 1989 |

*The range of binding energy of Al peak1 varies with the amount of Al doped in the structure.

The Al, B, and W surface contents as determined by XPS are expressed as a molar fraction of Al, B, and W, respectively, in the surface layer of the particles divided by the total content of Ni, Mn and Co in said surface layer. It is calculated as follows:

fraction of Al=Al_{B}=Al (at %)/(Ni (at %)+Mn (at %)+Co (at %))

fraction of B=B_{B}=B (at %)/(Ni (at %)+Mn (at %)+Co (at %))

fraction of W=W_{B}=W (at %)/(Ni (at %)+Mn (at %)+Co (at %)).

### 2. Examples and Comparative Examples

### Comparative Example 1

A single-crystalline positive electrode active material labelled as CEX1 is prepared according to the following steps:
Step 1) Transition metal oxidized hydroxide precursor preparation: A nickel-based transition metal oxidized hydroxide powder (TMH1) having a metal composition Ni_{0.86}Mn_{0.07}Co_{0.07} is prepared by a co-precipitation process in a large-scale continuous stirred tank reactor (CSTR) with mixed nickel manganese cobalt sulfates, sodium hydroxide, and ammonia.
Step 2) Heating: the TMH1 prepared from Step 1) is heated at 400° C. for 7 hours in an oxidizing atmosphere to obtain a heated powder.
Step 3) First mixing: the heated powder prepared from Step 2) is mixed with LiOH in an industrial blender so as to obtain a first mixture having a lithium to metal (Ni, Mn and Co) ratio of 0.96.
Step 4) First firing: The first mixture from Step 3) is fired at 890° C. for 11 hours in an oxidizing atmosphere so as to obtain a first fired powder.
Step 5) Wet bead milling: The first fired powder from Step 4) is bead milled in a solution containing 0.5 mol % Co with respect to the total molar contents of Ni, Mn, and Co in the first fired powder followed by dying and sieving process so as to obtain a milled powder. The bead milling solid to solution weight ratio is 6:4 for 20 minutes.
Step 6) Second mixing: the milled powder obtained from Step 5) is mixed in an industrial blender with 1.5 mol % Co from Co₃O₄, 0.25 mol % Zr from ZrO₂, and 7.5 mol % Li from LiOH, each with respect to the total molar contents of Ni, Mn, and Co in the milled powder so as to obtain a second mixture.
Step 7) Second firing: The second mixture from Step 6) is fired at 760° C. for 10 hours in an oxidizing atmosphere followed by crushing and sieving process together with alumina (Al₂O₃) powder. The sieved powder comprising 250 ppm Al is labelled as CEX4. The powder has a median particle size of about 4 μm, as determined by laser diffraction measured with a Malvern Mastersizer 3000.

### Example 1

EX1.1 is prepared according to the following process:
Step 1) Mixing: CEX1 is mixed with H₃BO₃ powder in an industrial blender so as to obtain a mixture comprising 500 ppm of B.
Step 2) Firing: Mixture from Step 1) is fired at 375° C. for 7 hours in an oxidizing atmosphere followed by grinding and sieving process. The product from this step is a grinded powder labelled as EX1.1.

Alumina powder in amount ranging from 250 to 1000 ppm Al, with respect to the total weight of the final product, can be added in the Step 2) grinding and sieving process as a free-flowing agent to assist the sieving step.

EX1.2 is prepared according to the same method as EX1.2 except that WO₃ powder is added in the Step 1) together with CEX1 to obtain a mixture comprising 500 ppm of B and 4500 ppm of W.

### Comparative Example 2

A single-crystalline positive electrode active material labelled as CEX2 is prepared according to the following steps:
Step 1) Transition metal oxidized hydroxide precursor preparation: A nickel-based transition metal oxidized hydroxide powder (TMH2) having a metal composition Ni_{0.90}Mn_{0.05}Co_{0.05} is prepared by a co-precipitation process in a large-scale continuous stirred tank reactor (CSTR) with mixed nickel manganese cobalt sulfates, sodium hydroxide, and ammonia.
Step 2) First mixing: the TMH2 prepared from Step 2) is mixed with LiOH in an industrial blender so as to obtain a first mixture having a lithium to metal (Ni, Mn and Co) ratio of 0.96.
Step 3) First firing: The first mixture from Step 2) is fired at 890° C. for 11 hours in an oxidizing atmosphere so as to obtain a first fired powder.
Step 4) Wet bead milling: The first fired powder from Step 3) is bead milled in a solution containing 0.5 mol % Co with respect to the total molar contents of Ni, Mn, and Co in the first fired powder followed by dying and sieving process so as to obtain a milled powder. The bead milling solid to solution weight ratio is 6:4.
Step 5) Second mixing: the milled powder obtained from Step 4) is mixed in an industrial blender with 3.0 mol % Co from Co₃O₄, with respect to the total molar contents of Ni, Mn, and Co in the milled powder so as to obtain a second mixture.
Step 6) Second firing: The second mixture from Step 5) is fired at 750° C. for 12 hours in an oxidizing atmosphere followed by crushing and sieving process together with alumina (Al₂O₃) powder. The sieved powder comprising 250 ppm Al is labelled as CEX4. The powder has a median particle size of about 3.5 μm, as determined by laser diffraction measured with a Malvern Mastersizer 3000.

### Example 2

EX2.1 is prepared according to the same method as EX1.1 except that CEX2 is used instead of CEX1 in Step 1).

EX2.2 is prepared according to the same method as EX1.2 except that CEX2 is used instead of CEX1 in Step 1).

### Comparative Example 3

CEX3 is prepared according to the same method as CEX2 except that a nickel-based transition metal oxidized hydroxide powder (TMH3) having a metal composition Ni_{0.92}Mn_{0.05}Co_{0.03} is prepared by a co-precipitation process in Step 10.

### Example 3

EX3.1 is prepared according to the same method as EX1.1 except that CEX3 is used instead of CEX1 in Step 1).

EX3.2 is prepared according to the same method as EX1.2 except that CEX3 is used instead of CEX1 in Step 1).

### Comparative Example 4

A single-crystalline positive electrode active material labelled as CEX4 is prepared according to the following steps:
Step 1) Transition metal oxidized hydroxide precursor preparation: A nickel-based transition metal oxidized hydroxide powder (TMH4) having a metal composition Ni_{0.73}Mn_{0.20}Co_{0.07} is prepared by a co-precipitation process in a large-scale continuous stirred tank reactor (CSTR) with mixed nickel manganese cobalt sulfates, sodium hydroxide, and ammonia.
Step 2) First mixing: the TMH4 prepared from Step 1) is mixed with LiOH in an industrial blender so as to obtain a first mixture having a lithium to metal (Ni, Mn and Co) ratio of 1.00.
Step 3) First firing: The first mixture from Step 2) is fired at 915° C. for 11 hours in an oxidizing atmosphere so as to obtain a first fired powder.
Step 4) Wet bead milling: The first fired powder from Step 3) is bead milled in a solution containing 0.5 mol % Co with respect to the total molar contents of Ni, Mn, and Co in the first fired powder followed by crushing and sieving process so as to obtain a milled powder. The bead milling solid to solution weight ratio is 65%.
Step 5) Second mixing: the milled powder obtained from Step 4) is mixed in an industrial blender with 2.0 mol % Co from Co₃O₄ powder, 0.25 mol % Zr from ZrO₂ powder, and 8.5 mol % Li from LiOH, each with respect to the total molar contents of Ni, Mn, and Co in the milled powder so as to obtain a second mixture.
Step 6) Second firing: the second mixture from Step 5) is fired at 775° C. for 12 hours in an oxidizing atmosphere so as to obtain a second fired body.
Step 7) Grinding and sieving: the second fired body obtained from Step 6) is grinded and sieved together with alumina powder. The sieved powder comprising 500 ppm Al is labelled as CEX4. The powder has a median particle size of 3.5 μm, as determined by laser diffraction measured with a Malvern Mastersizer 3000.

### Example 4

EX4.1 is prepared according to the same method as EX1.1 except that CEX4 is used instead of CEX1 in Step 1) and 500 ppm of Al from alumina powder is added in the Step 2).

EX4.1 is prepared according to the same method as EX1.2 except that CEX4 is used instead of CEX1 in Step 1) and 500 ppm of Al from alumina powder is added in the Step 2).

Due to the wet milling, the abovementioned examples and comparative examples are single-crystalline powders.

### Comparative Example 5

A single-crystalline positive electrode active material labelled as CEX5.1 is prepared according to the following steps:
Step 1) Transition metal oxidized hydroxide precursor preparation: A nickel-based transition metal oxidized hydroxide powder (TMH5) having a metal composition Ni_{0.68}Mn_{0.27}Co_{0.05} is prepared by a co-precipitation process in a large-scale continuous stirred tank reactor (CSTR) with mixed nickel manganese cobalt sulfates, sodium hydroxide, and ammonia.
Step 2) First mixing: the TMH5 prepared from Step 1) is mixed with LiOH in an industrial blender so as to obtain a first mixture having a lithium to metal (Ni, Mn and Co) ratio of 1.03.
Step 3) First firing: The first mixture from Step 2) is fired at 925° C. for 10 hours in an oxidizing atmosphere so as to obtain a first fired powder followed by air jet milling and sieving.
Step 4) Second mixing: the milled powder obtained from Step 3) is mixed in an industrial blender with 500 ppm Al from Al₂O₃, 2.0 mol % Co from Co₃O₄ powder, 0.25 mol % Zr from ZrO₂ powder, and 2.0 mol % Li from LiOH, each with respect to the total molar contents of Ni, Mn, and Co in the milled powder so as to obtain a second mixture.
Step 5) Second firing: the second mixture from Step 4) is fired at 775° C. for 12 hours in an oxidizing atmosphere so as to obtain a second fired body.
Step 6) Grinding and sieving: the second fired body obtained from Step 5) is grinded and sieved together with alumina powder. The sieved powder comprising 500 ppm Al is labelled as CEX5.1. The powder has a median particle size of 4 μm, as determined by laser diffraction measured with a Malvern Mastersizer 3000.

Due to the air jet milling in Step 3) CEX 5.1 is a single-crystalline powder.

CEX5.2 is prepared according to the same method as EX1.1 except that CEX5.1 is used instead of CEX1 in Step 1), firing time is 9 hours, and 500 ppm of Al from alumina powder is added in the grinding process of Step 2).

CEX5.2 is according to document US 2016/336595.

TABLE 3
Summary of the composition and the corresponding electrochemical
properties of example and comparative examples.

| | | | | | Coin cell | |
|---|---|---|---|---|---|---|
| | ICP * (expressed as mol %, relative to M′) | | | | DQ1 | IRRQ |
| ID | Ni | Al | B | W | (mAh/g) | (%) |
| CEX1 | 84.02 | 0.08 | 0.00 | 0.00 | 209.5 | 10.00 |
| EX1.1 | 83.81 | 0.09 | 0.39 | 0.00 | 216.6 | 8.65 |
| EX1.2 | 83.51 | 0.07 | 0.40 | 0.22 | 215.3 | 8.48 |
| CEX2 | 87.18 | 0.09 | 0.00 | 0.00 | 213.5 | 10.19 |
| EX2.1 | 86.92 | 0.08 | 0.39 | 0.00 | 221.1 | 8.82 |
| EX2.2 | 86.73 | 0.08 | 0.39 | 0.23 | 220.6 | 8.23 |
| CEX3 | 88.95 | 0.08 | 0.00 | 0.00 | 215.5 | 9.76 |
| EX3.1 | 88.63 | 0.07 | 0.39 | 0.00 | 220.5 | 9.09 |
| EX3.2 | 88.46 | 0.08 | 0.40 | 0.23 | 222.2 | 8.61 |
| CEX4 | 71.19 | 0.22 | 0.00 | 0.00 | 183.5 | 12.43 |
| EX4.1 | 71.07 | 0.35 | 0.43 | 0.00 | 186.7 | 11.48 |
| EX4.2 | 71.07 | 0.32 | 0.45 | 0.10 | 185.9 | 11.72 |
| CEX5.1 | 67.56 | 0.33 | 0.00 | 0.00 | 169.5 | 15.11 |
| CEX5.2 | 67.29 | 0.53 | 0.36 | 0.00 | 168.1 | 14.43 |

*as calculated by ICP measurement, M′ is a total molar fraction of other elements as analyzed by ICP

TABLE 4
XPS analysis result of EX1.1 and EX1.2 and the ratio with ICP analysis

| | ICP* | | | XPS** | | | XPS/ICP | | |
|---|---|---|---|---|---|---|---|---|---|
| ID | Al_{A} | B_{A} | W_{A} | Al_{B} | B_{B} | W_{B} | Al | B | W |
| EX1.1 | 0.0009 | 0.0039 | 0.0000 | 0.32 | 1.68 | 0.00 | 351 | 430 | n/a |
| EX2.2 | 0.0008 | 0.0039 | 0.0024 | 0.28 | 1.56 | 0.37 | 354 | 400 | 154 |
| EX4.2 | 0.0026 | 0.0045 | 0.0010 | 1.18 | 0.57 | 0.24 | 473 | 127 | 239 |

*calculated versus the total molar fraction of Ni, Mn, and Co as analyzed by ICP
**calculated versus the total molar fraction of Ni, Mn, and Co as analyzed by XPS

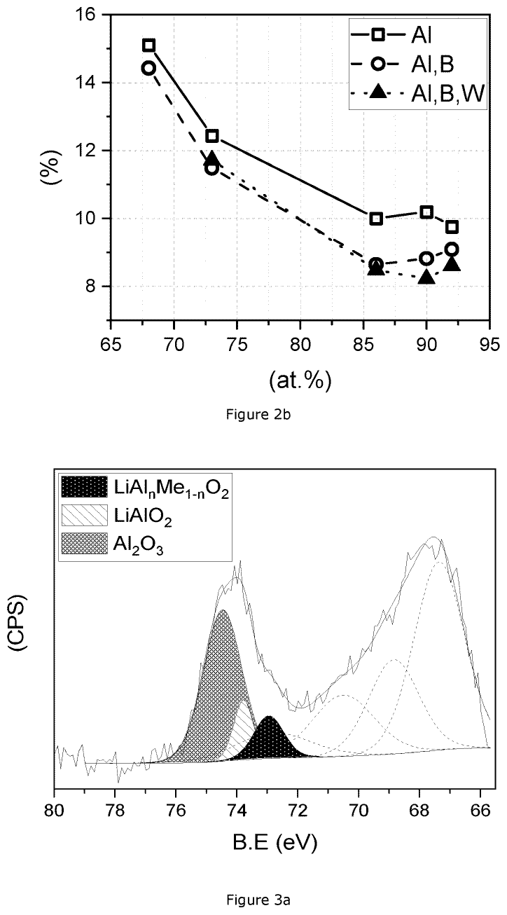

Table 3 summarizes the composition of examples and comparative examples and their corresponding electrochemical properties. FIGS. 2a and 2b depict the electrochemical properties in the Table 3 as a function of Ni content in the positive electrode active material. In FIGS. 2a and 2b, it is clearly seen that subsequent Al and B presence is advantageous to increase DQ1 and decrease IRRQ of the positive electrode active material with Ni content between 70 mol % and 95 mol %, relative to M′. Moreover, the subsequent presence of Al, B, and W also increases DQ1 and decreases IRRQ in the same trend as the positive electrode active material comprising Al and B in comparison to the comparative examples. EX1.2, EX2.2, and EX3.2 shows further decrement of IRRQ when Al, B, and W presence altogether in the positive electrode active material in comparison to EX1.1, EX2.1 and EX3.1.

Table 4 summarized the XPS analysis result of EX1.1 and EX1.2 showing Al, B, and W molar ratio with respect to the total molar fraction of Ni, Mn, and Co. The table also compares the result with that of ICP. The molar ratio higher than 0 indicating said Al, B, and W are presence in the surface of the positive electrode active material as associated with the XPS measurement which signal is acquired from the first few nanometers (e.g. 1 nm to 10 nm) of the uppermost part of a sample, i.e. surface layer. On the other hand, Al, B, and W molar ratio obtained from ICP measurement is from the entire particles. Therefore, the ratio of XPS to ICP of higher than 0 indicating said elements Al, B, or W presence mostly on the surface of the positive electrode active material. The ratio of XPS to ICP of higher than 0 is observed for Al and B in EX1.1 and Al, B, and W in EX2.2 and EX4.2.

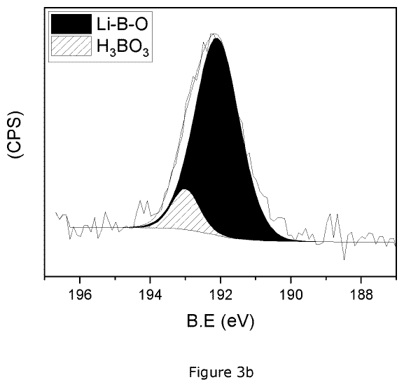

Furthermore, XPS peak location is associated with compounds derived from the preparation process. FIG. 3a shows Al peak of EX4.2 which overlap with Ni3p peak and FIG. 3b shows B1s peak of EX4.2. Peak deconvolution is performed to separate contribution of each compounds based on the peak location according to the references listed in Table 2c. Three different Al comprising compounds and Ni3p contributions are separated FIG. 3a, wherein the result shows, EX4.2 comprises Al₂O₃, LiAlO₂, and LiAlₙMe₁₋ₙO₂ on the surface. In FIG. 3b, B1s peak is deconvoluted to a peak belong to H₃BO₃ and another peak belong to Li—B—O compounds having a similar peak position. The Li—B—O compounds can be, but not limited to, Li₂B₄O₇ and Li₄B₂O₅.

1-13. (canceled)

14. A positive electrode active material for lithium-ion rechargeable batteries, wherein the positive electrode active material is a powder, wherein the positive electrode active material comprises Li, M′, and oxygen, wherein M′ comprises:
Ni in a content a between 70.0 mol % and 95.0 mol %, relative to M′,
Co in a content x between 0.0 mol % and 25.0 mol %, relative to M′,
Mn in a content y between 0.0 mol % and 25.0 mol %, relative to M′,
D in a content z between 0.0 mol % and 2.0 mol %, relative to M′, wherein D comprises at least one element of the group consisting of: Ba, Ca, Cr, Fe, Mg, Mo, Nb, S, Si, Sr, Ti, Y, V, Zn, W, and Zr, and,
Al and B, wherein the total content c of Al and B is between 0.1 mol % and 5.0 mol %, relative to M′,
wherein a, x, y, z, and c are measured by ICP,
wherein a+x+y+c+z is 100.0 mol %,
wherein the positive electrode active material has an Al content Al_{A} and a B content B_{A}, wherein Al_{A} and B_{A} are determined by ICP analysis, wherein Al_{A}, and B_{A} are expressed as molar fractions compared to the sum of a and x and y,
wherein the powder, when measured by XPS analysis, shows an average Al fraction Al_{B} and an average B fraction B_{B}, wherein Al_{B} and B_{B} are expressed as molar fractions compared to the sum of the fractions of Co, Mn and Ni as measured by XPS analysis,
wherein the ratio Al_{B}/Al_{A}>1.0,
wherein the ratio B_{B}/B_{A}>1.0, and
wherein the powder is a single-crystalline powder.

15. Positive electrode active material according to claim 14, wherein the ratio Al_{B}/Al_{A}>10.

16. Positive electrode active material according to claim 14, wherein the ratio Al_{B}/Al_{A}<800.

17. Positive electrode active material according to claim 14, wherein the ratio B_{B}/B_{A}>10.

18. Positive electrode active material according to claim 14, wherein the ratio B_{B}/B_{A}<500.

19. Positive electrode active material according to claim 14, wherein the positive electrode active material has a W content W_{A}, wherein W_{A} is determined by ICP analysis and expressed as molar fraction compared to the sum of a and x and y, wherein the positive electrode active material, when measured by XPS analysis, shows an average W fraction W_{B}, wherein W_{B} is expressed as molar fraction compared to the sum of the fractions of Co, Mn and Ni as measured by XPS analysis, wherein the ratio W_{B}/W_{A}>1.0.

20. Positive electrode active material according to claim 19, wherein the ratio W_{B}/W_{A}>10.

21. Positive electrode active material according to claim 19, wherein the ratio W_{B}/W_{A}<500.

22. Positive electrode active material according to claim 14, wherein the positive electrode active material has a median particle size D50 of between 2.0 μm and 7.0 μm, as determined by laser diffraction particle size analysis.

23. Positive electrode active material according to claim 14, wherein M′ comprises Al and B and W, each in a content of at least 0.02 mol %, relative to M′, as measured by ICP.

24. Positive electrode active material according to claim 14, wherein a is more than 75 mol %, relative to M′, as measured by ICP.

25. Battery cell comprising a positive electrode active material according to claim 14.

26. A portable computer, a tablet, a mobile phone, an electrically powered vehicle, or an energy storage system comprising the positive electrode active material according to claim 14.
